(19) United States
(12) Patent Application Publication
(10) Pub. No.: US 2017/0292689 A1
(43) Pub. Date: Oct. 12, 2017

(54) LED LIGHTING DEVICE DIRECTLY COUPLED TO POWER SUPPLY UNIT

(71) Applicant: KMW INC., Hwaseong-si (KR)

(72) Inventors: Dong Sik ROH, Seoul (KR); Hyun Ki KIM, Seoul (KR); Byung Ju KANG, Incheon (KR)

(73) Assignee: KMW INC.

(21) Appl. No.: 15/632,277

(22) Filed: Jun. 23, 2017

Related U.S. Application Data
(63) Continuation of application No. PCT/KR2015/014513, filed on Dec. 30, 2015.

(30) Foreign Application Priority Data
Jan. 2, 2015 (KR) 10-2015-0000133

(51) Int. Cl. F21V 23/06; F21V 29/74

(52) U.S. Cl. CPC F21V 23/06; F21V 29/74

(57) ABSTRACT

An LED lighting device directly coupled to a power supply unit includes: a lighting unit (100) having a mounting space (150), in the bottom of which a substrate (120) mounted with LEDs is mounted, with a plurality of heat dissipation fins (140) provided on an upper portion of the lighting unit (100); a power connection unit (300) protruding upward from the upper portion of the lighting unit (100) and having a power connection hole (310) capable of supplying power to the substrate (120); and a power supply unit (200) that is a switching mode power supply (SMPS) coupled to the power connection unit (300) to supply power to the substrate (120). The LED lighting device has a simple structure and is capable of reducing the production cost.

### CROSS-REFERENCE TO RELATED APPLICATIONS

This application is a continuation of International Application No. PCT/KR2015/014513 filed on Dec. 30, 2015, which claims priority to Korean Application No. 10-2015-0000133 filed on Jan. 2, 2015, the entire contents of which are incorporated herein by reference.

### TECHNICAL FIELD

Exemplary embodiments of the present disclosure relates to an LED lighting device directly coupled to a power supply unit, and more particularly, to an LED lighting device directly coupled to a power supply unit which employs a simple structure and does not need a separate power supply unit housing, thus reducing the production cost.

### BACKGROUND ART

Lighting apparatuses using LEDs as light sources are being developed in consideration of problems, such as high power consumption, short lifetime, and the like, of typical light source means. In the case where an LED is used as a light source, it is expected that, because the lifetime of a lighting apparatus is markedly increased compared to that of a typical light source, the amount of waste production is markedly reduced so that environmental contamination can be reduced, and it can contribute to energy conservation thanks to low power consumption.

Such an LED lighting device includes a switching-mode power supply (SMPS) configured to supply direct-current power to a substrate on which LEDs are mounted. Conventional LED lighting devices are classified into a type in which the SMPS is integrally formed with a lighting unit, and a type in which the SMPS is provided separately from the lighting unit and provided in a separate housing.

For example, in Korean Utility Model Registration No. 20-0451090 (Registration date: Nov. 18 2010, entitled “LED scenery lighting lamp mounted with SMPS”), there was proposed a structure in which an SMPS is disposed to come into contact with a rear surface of a casing in which a substrate is mounted.

However, this technique has a configuration in which the SMPS comes into contact with the casing mounted with the substrate and is sealed by a bracket. This configuration is problematic in that heat exchange is caused between the SMPS generating heat and the substrate on which LEDs are mounted, whereby the lifetimes of both the SMPS and the LEDs may be reduced.

Heat generated from the SMPS is trapped by the bracket, so that heat dissipation is impeded.

Such a structure was also introduced in Korean Patent Registration No. 10-1132783 (Registration date: Mar. 27, 2012, entitled “LED streetlamp”). Referring to FIG. 4 of this registered patent, heat dissipation fins are provided at a side opposite to a frame on which a substrate mounted with LEDs is installed. An SMPS is fixed on an upper portion of the heat dissipation fins, and a lower cover and an upper cover are installed based on the frame.

The registered patent differs from the registered utility model in that the SMPS is installed on the heat dissipation fins. However, because the heat dissipation fins and the SMPS are substantially blocked from the outside by the upper cover, the heat dissipation efficiency is reduced, and it is difficult to prevent heat exchange between the SMPS and the LEDs.

As such, in the conventional techniques, the LED lighting devices integrally provided with the SMPS are problematic in that heat exchange between the LEDs and the SMPS is caused, and the production cost is increased because a separate cover must be provided around the SMPS.

In an effort to overcome the above-mentioned problems, there was proposed a lighting device in which an SMPS is completely separated from a lighting unit to overcome the problem of heat exchange therebetween. In Korea Patent Registration No. 10-1399381 (Registration date: May 20, 2014, entitled “LED lighting device”) filed by the applicant of the present disclosure, a separate power supply housing spaced apart from a lighting unit is provided to completely prevent heat exchange between the lighting unit and a power supply unit, thus preventing a reduction in the lifetime of an SMPS and LEDs.

This configuration has high heat dissipation efficiency and is able to prevent heat transfer between the lighting unit and the power supply unit. However, since a separate power supply housing must be provided, the production cost and the weight of the device are increased.

Furthermore, the above-mentioned conventional techniques have a complex housing structure because an external AC power supply cable must be connected to the SMPS, and DC constant power provided from the SMPS must be supplied to the substrate. Thus, a machining process is complex, and the time it takes to assembly parts of a product is relatively increased. Therefore, there is a problem in that the productivity is reduced.

### DISCLOSURE

### Technical Problem

An embodiment of the present disclosure relates to an LED lighting device directly coupled to a power supply unit which can be configured without a separate power supply housing.

Another embodiment of the present disclosure relates to an LED lighting device which has excellent heat dissipation efficiency and is able to prevent heat transfer between a lighting unit and the power supply unit.

Yet another embodiment of the present disclosure relates to an LED lighting device in which the configuration of the power supply unit can be simplified, whereby the production cost can be reduced, and which has a simple structure so that the number of coupling elements can be minimized, thus enhancing the productivity.

### Technical Solution

An LED lighting device directly coupled to a power supply unit in accordance with a first embodiment of the present disclosure may include: a lighting unit (100) having a mounting space (150), in a bottom of which a substrate (120) mounted with an LED is fixed, with a plurality of heat dissipation fins (140) provided on an upper portion of the lighting unit (100); a power connection unit (300) protruding upward from a central portion of the upper portion of the lighting unit (100) and having a power connection hole (310) formed to enable power to be supplied to the substrate (120); and a power supply unit (200) coupled to an upper portion of the power connection unit (300) and formed of a switching-mode power supply (SMPS) configured to supply power to the substrate (120).

### Advantageous Effects

An LED lighting device directly coupled to a power supply unit in accordance with the present disclosure includes a lighting unit which includes a wire connection unit on an upper central portion thereof, and a power supply unit which is directly coupled to the wire connection unit. Because there is no need of a separate power supply unit housing, the structure of the LED lighting device is simple, whereby the production cost can be reduced.

Furthermore, in the present disclosure, the wire connection unit extends a relatively long length from the lighting unit upward so that a sufficient distance can be secured between the lighting unit and the power supply unit, thus preventing heat transfer between the lighting unit and the power supply unit, thereby preventing a reduction in the lifetime of the lighting unit and the power supply unit.

### DESCRIPTION OF DRAWINGS

FIG. 1 is an exploded perspective view illustrating an LED lighting device directly coupled to a power supply unit according to an embodiment of the present disclosure.

FIG. 2 is an assembled perspective view of FIG. 1.

FIG. 3 is a sectional view taken along line A-A of FIG. 2.

FIG. 4 is a sectional view illustrating the configuration of an LED lighting device directly coupled to a power supply unit according to another embodiment of the present disclosure.

FIG. 5 is a view illustrating the configuration of a power connector of FIG. 4.

FIG. 6 is a view illustrating the configuration of another embodiment of the power connector.

FIG. 7 is a sectional view illustrating the configuration of an LED lighting device directly coupled to a power supply unit according to another embodiment of the present disclosure.

FIG. 8 is a view illustrating the configuration of an angle adjustment unit of FIG. 7.

FIG. 9 is a partial perspective view of FIG. 7.

### MODE FOR INVENTION

Hereinafter, an LED lighting device directly coupled to a power supply unit according to the present disclosure will be described in detail with reference to the attached drawings.

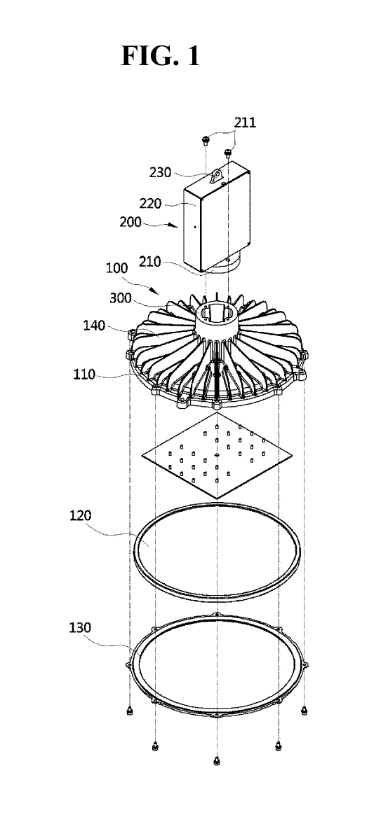

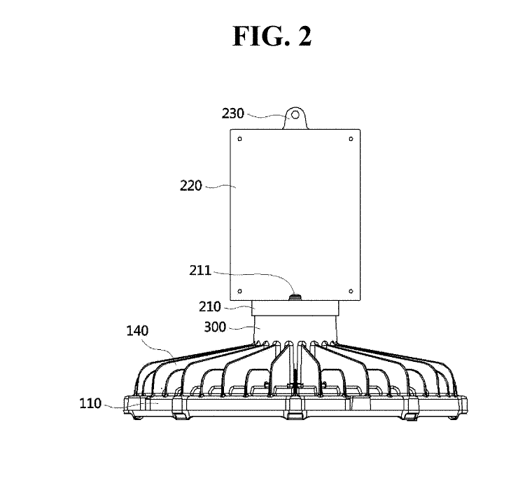

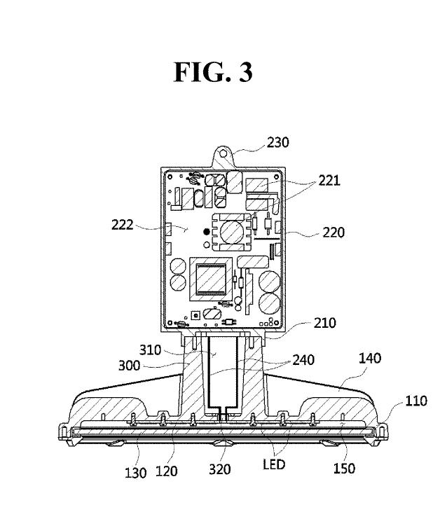

FIG. 1 is an exploded perspective view illustrating an LED lighting device directly coupled to a power supply unit according to an embodiment of the present disclosure. FIG. 2 is an assembled perspective view of FIG. 1. FIG. 3 is a sectional view taken along line A-A of FIG. 2.

Referring to FIGS. 1 to 3, the LED lighting device according to the embodiment of the present disclosure includes: a lighting unit 100 having a mounting space 150, in the bottom of which a substrate 120 mounted with LEDs is fixed, and a plurality of heat dissipation fins 140 provided on an upper portion of the lighting unit 100; a power connection unit 300 which protrudes upward from a central portion of the upper portion of the lighting unit 100 and has in a central portion thereof a power connection hole 310 formed to enable power to be supplied to the substrate 120; and a power supply unit 200 which is coupled to an upper end of the power connection unit 300 and configured to supply power to the substrate 120.

Hereinbelow, the configuration and operation of the LED lighting device according to the embodiment of the present disclosure having the above-mentioned configuration will be described in more detail.

The lighting unit 100 may include a disk-shaped main body 110 which defines the mounting space 150 therein, the plurality of heat dissipation fins 140 provided on an upper portion of the main body 110, the substrate 120 which is disposed in the mounting space 150 on an inner top surface of the main body 110, and on which the plurality of LEDs are mounted, and a cover unit 130 which covers the mounting space 150.

The heat dissipation fins 140 of the lighting unit 100 may form a structure in which they radially extend toward an outer edge of the main body 110 from a periphery of the power connection unit 300 disposed in the central portion of the upper portion of the lighting unit 100.

The main body 110 and the heat dissipation fins 140 are integrally formed. For the sake of description, although the lighting unit 100 including the main body 110 and the power connection unit 300 are described as being separated provided, it is preferable in terms of the purpose of the present disclosure that the main body 110 and the power connection unit 300 be substantially integrally formed.

The power connection unit 300 protrudes upward from the central portion of the upper portion of the main body 110 and has a cylindrical or polygonal barrel shape. That is, the power connection unit 300 provides a passage in which the power connection hole 310 is provided so that power of the power supply unit 200 which will be described later herein can be supplied to the substrate 120 of the lighting unit 100.

The power connection hole 310 is a hole which extends downward from an upper surface of the power connection unit 300. Here, the power connection hole 310 that extends downward from the upper surface of the power connection unit 300 may pass through even the mounting space 150.

However, if the power connection hole 310 which is relatively large passes through even the mounting space 150, the surface area of the substrate 120 that is exposed through the power connection hole 310 is increased. In consideration of the fact that there is no unit for directly dissipating heat on a corresponding portion of the substrate 120, it is preferable that a passing hole 320 having a diameter smaller than that of the power connection hole 310 be formed in the junction between the power connection hole 310 and the mounting space 150.

The power connection hole 310 is a space in which electric wires or electric contacts provided on the substrate 120 are coupled with electric wires 240 or electric contacts of provided on the power supply unit 200.

The power supply unit 200 is a switching-mode power supply (SMPS) and is characterized in that there is no separate housing for covering the SMPS. The power supply unit 200 includes a container 220 which receives a substrate 222 mounted with electronic elements 221 constituting the SMPS, and an insert coupling unit 210 which protrudes downward from a lower portion of the container 220 and is fixed to the power connection unit 300 by inserting a portion of an upper end of the power connection unit 300 into the insert coupling unit 210 and fastening them with each other using a bolt 211.

The insert coupling unit 210 has a disk structure, which partially protrudes toward a side surface of the container 220 having a cuboid shape. The bolt 211 is inserted downward into the protrusion of the insert coupling unit 210 and tightened into the upper end of the power connection unit 300.

In the present disclosure, because the power supply unit 200 itself is a unit for coupling the lighting unit 100 to a ceiling, or an arm for lighting, a coupling ring 230 may be further provided on an upper portion of the power supply unit 200.

Although not shown, the container 220 of the power supply unit 200 generally has a structure filled with molding material for dissipating heat generated from the electronic elements 221.

To couple the power supply unit 200 and the lighting unit 100 having the above-mentioned configurations to each other, the power connection unit 300 is inserted into the insert coupling unit 210 of the power supply unit 200, and then the bolt 211 is fastened to overlapped portions of the insert coupling unit 210 and the power connection unit 300.

Therefore, an assembly process for manufacturing the LED lighting device can be simplified so that the production cost can be reduced, and the productivity can be enhanced.

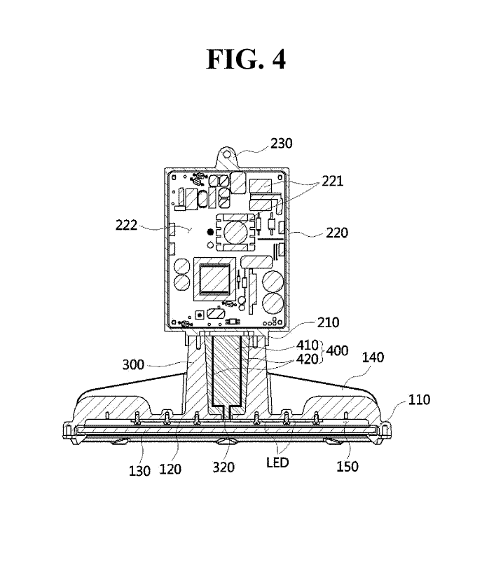

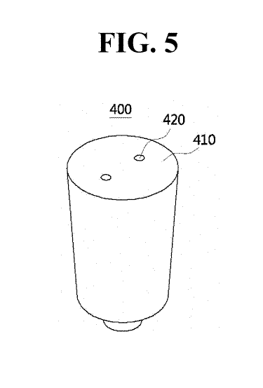

FIG. 4 is a sectional view illustrating the configuration of an LED lighting device directly coupled to a power supply unit according to another embodiment of the present disclosure. FIG. 5 is a perspective view illustrating the configuration of a power connector 400 of FIG. 4.

Referring to FIGS. 4 and 5, the LED lighting device according to this embodiment of the present disclosure further includes a power connector 400 which is installed in the power connection hole 310 and the through hole 320 on the basis of the configuration described with reference to FIGS. 1 to 3.

The power connector 400 includes a connector body 410 having a shape such that it is tightly inserted into the power connection hole 310 and the through hole 320, and a power connection terminal 420 which is made of a conductor and is vertically installed in the connector body 410.

The power connector 400 is inserted into the power connection hole 310 and the through hole 320 such that it does not undesirably move. The power connector 400 connects the substrate 120 with a power terminal of the power supply unit 200 using the power connection terminal 420 so that there is no need to perform a separate wire connection work.

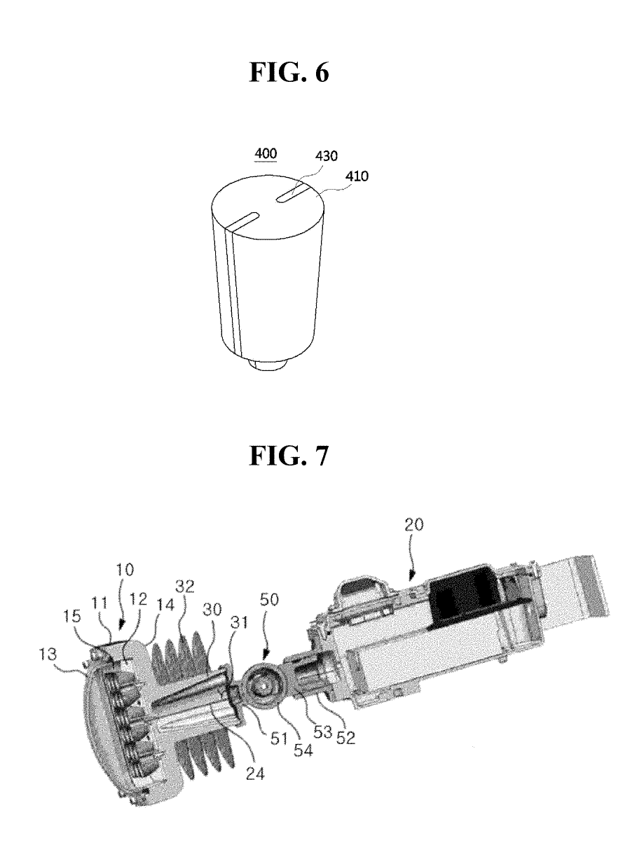

FIG. 6 is a view illustrating the configuration of another embodiment of the power connector 400 used in the LED lighting device according to the present disclosure.

Referring to FIG. 6, the power connector 400 used in the LED lighting device according to the present disclosure includes a connector body 410 which has a shape such that it can be tightly inserted into the power connection hole 310 and the through hole 320, and a power connection terminal 430 which is made of a conductor and is vertically installed along a side surface of the connector body 410 such that respective portions thereof are disposed in upper and lower surfaces of the connector body 410.

In this case, the power connection terminal 430 also connects the substrate 120 with the power terminal of the power supply unit 200 so that there is no need for a worker to perform a separate wire connection work, thus enhancing the productivity.

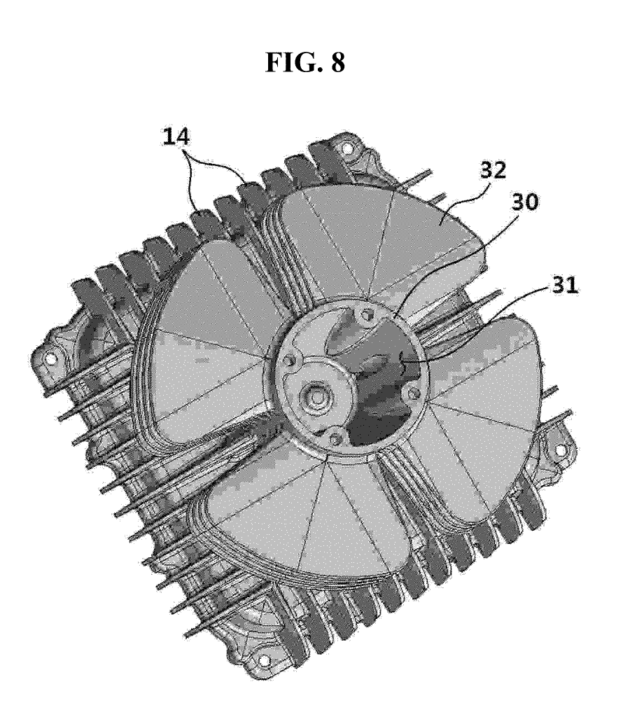

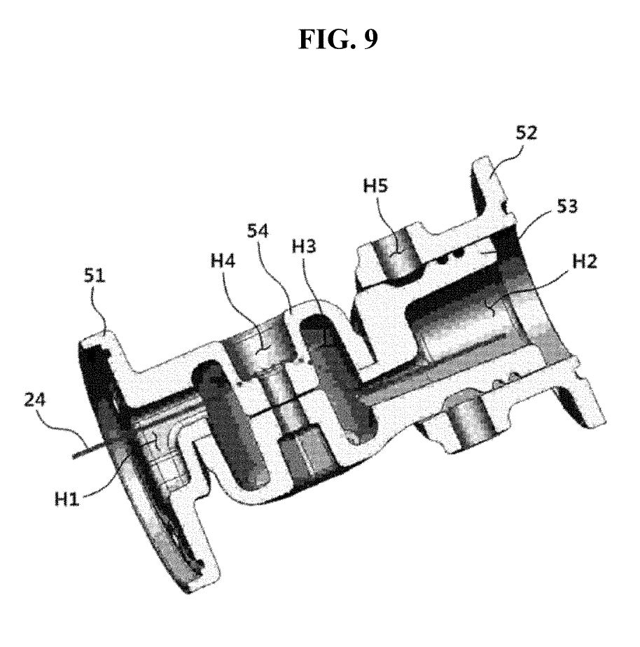

FIG. 7 is a sectional view illustrating the configuration of an LED lighting device directly coupled to a power supply unit according to another embodiment of the present disclosure. FIG. 8 is a sectional view illustrating the configuration of an angle adjustment unit 50 of FIG. 7.

Referring to FIGS. 7 and 8, the LED lighting device according to this embodiment of the present disclosure includes a power connection unit 30 which is integrally provided in the lighting unit 10, and a power supply unit 20 which supplies power to the lighting unit 10 through the power connection unit 30.

The LED lighting device according to this embodiment further includes an angle adjustment unit 50 which is coupled between the power supply unit 20 and the power connection unit 30 and configured to adjust the angle of the lighting unit 10.

Although the shape of the lighting unit 10 differs from that of the lighting unit 100 described with reference to FIGS. 1 to 4, this shows that the present disclosure can have various embodiments.

The lighting unit 10 includes a main body 11 which has a mounting space 15 in which a substrate 12 is received. The power connection unit 30 is integrally provided on a central portion of a rear surface of the main body 11. The mounting space 15 in which the substrate 12 is received communicates with a power connection hole 31 formed in the power connection unit 30.

Heat dissipation fins 14 are provided on the entirety of the outer surface of the main body 11.

FIG. 7 is a partial perspective view illustrating the shape of a radial heat dissipation fin 32 used in the present disclosure. Unlike the preceding embodiment, a plurality of radial heat dissipation fins 32 are radially provided on the outer surface of the power connection unit 30. This makes it possible to more effectively dissipate heat generated from the LEDs mounted on the substrate 12 in the structure in which the main body 11 and the power connection unit 30 are integrally provided with each other.

The angle adjustment unit 50 is coupled to the power connection unit 30.

The angle adjustment unit 50 includes a first coupling unit 51 which is coupled to the power connection unit 30, a second coupling unit 52 which is coupled to the power supply unit 20, a rotation adjustment unit 53 which is inserted into the second coupling unit 52 and configured to allow the rotation angle of the lighting unit 10 to be adjusted by rotation of the rotation adjustment unit 53, and a tilting adjustment unit 54 which is disposed between the rotation adjustment unit 53 and the first coupling unit 51 and configured to adjust a tilting angle therebetween.

Each of the first and second coupling units 51 and 52 has a tubular structure. The first coupling unit 51 is fastened to the upper end of the power connection unit 30 by a fastening unit such as a bolt. The first coupling unit 51 has therein a through hole H1 through which an electric wire 24 of the power supply unit 20 can pass.

In a similar manner as the first coupling unit 51, the second coupling unit 52 is coupled to the power supply unit 20 and has a hole into which one end of the rotation adjustment unit 53 can be inserted. A through hole H5 is formed in a side surface of the second coupling unit 52 so that a side surface of the rotation adjustment unit 53 that is disposed in the second coupling unit 52 is exposed through the through hole H5. Furthermore, a stopper is inserted into the through hole H5 so that the rotation adjustment unit 53 can be prevented from being undesirably removed from the second coupling unit 52. In a state in which the stopper has been removed, the rotation angle can be adjusted.

The tilting adjustment unit 54 is substantially provided by coupling side surfaces of respective second ends of the first coupling unit 51 and the rotation adjustment unit 53 to each other. A coupling hole H4 is formed in the junction between the first coupling unit 51 and the rotation adjustment unit 53 so that they are coupled to each other by a hinge.

A cylindrical through hole H3 is formed in the junction around the hinge so that the electric wire 24 can extend into the power connection hole 31 of the power connection unit 30 through the through hole H1 of the first coupling unit 51 via the through hole H2 of the rotation adjustment unit 53.

Therefore, as shown in this embodiment of the present disclosure, although the LED lighting device includes the additional angle adjustment unit 50, the power of the power unit 200 can be easily connected to the substrate 12 of the lighting unit 10 through the power connection unit 30.

Also, in this embodiment, the mounting space 15 can communicate with the power connection hole 31 through a through hole having a diameter less than that of the power connection hole 31. The above-described power connector 400 can also be used.

While various embodiments have been described above, it will be understood to those skilled in the art that the embodiments described are by way of example only. Accordingly, the disclosure described herein should not be limited based on the described embodiments.

### INDUSTRIAL APPLICABILITY

The present disclosure simplifies a power connection structure of an LED lighting device and thus reduces the production cost, so that the invention has industrial applicability.

What is claimed is:

1. An LED lighting device directly coupled to a power supply unit, comprising:
a lighting unit having a mounting space, in a bottom of which a substrate mounted with an LED is fixed, with a plurality of heat dissipation fins provided on an upper portion of the lighting unit;
a power connection unit protruding upward from a central portion of the upper portion of the lighting unit and having a power connection hole formed to enable power to be supplied to the substrate; and
a power supply unit coupled to an upper portion of the power connection unit and formed of a switching-mode power supply (SMPS) configured to supply power to the substrate.

2. The LED lighting device according to claim 1, wherein the lighting unit and the power connection unit are integrally formed with each other.

3. The LED lighting device according to claim 1, further comprising:
an angle adjustment unit coupled between the power connection unit and the power supply unit and configured to supply constant power of the power supply unit to the power connection unit, the angle adjustment unit being capable of adjusting a rotation angle and a tilt angle of the lighting unit.

4. The LED lighting device according to claim 3, wherein the angle adjustment unit comprises:
a first coupling unit coupled to the power connection unit;
a second coupling unit coupled to the power supply unit;
a rotation adjustment unit inserted into the second coupling unit and configured to enable the rotation angle of the lighting unit to be adjusted by rotation of the rotation adjustment unit; and
a tilting adjustment unit disposed between the rotation adjustment unit and the first coupling unit and configured to adjust the tilting angle,
wherein a through hole through which an electric wire of the power supply unit passes is formed through all of the first coupling unit, the second coupling unit, the rotation adjustment unit, and the titling adjustment unit.

5. The LED lighting device according to claim 1, wherein the substrate is exposed upward through a through hole having a diameter less than a diameter of the power connection hole, rather than being exposed through the power connection hole, such that supply of power is possible.

6. The LED lighting device according to claim 5, further comprising:
a coupling ring provided on an upper portion of the power supply unit so that the power supply unit can be coupled to a ceiling or an arm for lighting.

7. The LED lighting device according to claim 6, further comprising:
a power connector tightly inserted into the through hole and the power connection hole and configured to supply power of the power supply unit to the substrate.

8. The LED lighting device according to claim 7, wherein the power connector comprises a connector body having a shape suitable for being tightly inserted into the through hole and the power connection hole, and a plurality of power connection terminals formed to pass upward and downward through the connector body.

9. The LED lighting device according to claim 7, wherein the power connector comprises a connector body having a shape suitable for being tightly inserted into the through hole and the power connection hole, and a plurality of power connection terminals disposed upward and downward in a side surface of the connector body such that portions of each of the power connection terminals are disposed in upper and lower surface of the connector body.

10. The LED lighting device according to claim 1, further comprising:
an insert coupling unit provided under a lower portion of the power supply unit and configured to couple the power supply unit with the power connection unit by fastening a bolt in a state in which a portion of the power connection unit is inserted into the insert coupling unit.

11. The LED lighting device according to claim 2, further comprising:
an angle adjustment unit coupled between the power connection unit and the power supply unit and configured to supply constant power of the power supply unit to the power connection unit, the angle adjustment unit being capable of adjusting a rotation angle and a tilt angle of the lighting unit.

12. The LED lighting device according to claim 11, wherein the angle adjustment unit comprises:
a first coupling unit coupled to the power connection unit;
a second coupling unit coupled to the power supply unit;
a rotation adjustment unit inserted into the second coupling unit and configured to enable the rotation angle of the lighting unit to be adjusted by rotation of the rotation adjustment unit; and
a tilting adjustment unit disposed between the rotation adjustment unit and the first coupling unit and configured to adjust the tilting angle,
wherein a through hole through which an electric wire of the power supply unit passes is formed through all of the first coupling unit, the second coupling unit, the rotation adjustment unit, and the titling adjustment unit.

13. The LED lighting device according to claim 2, wherein the substrate is exposed upward through a through hole having a diameter less than a diameter of the power connection hole, rather than being exposed through the power connection hole, such that supply of power is possible.

14. The LED lighting device according to claim 13, further comprising:
a coupling ring provided on an upper portion of the power supply unit so that the power supply unit can be coupled to a ceiling or an arm for lighting.

15. The LED lighting device according to claim 14, further comprising:
a power connector tightly inserted into the through hole and the power connection hole and configured to supply power of the power supply unit to the substrate.

16. The LED lighting device according to claim 15, wherein the power connector comprises a connector body having a shape suitable for being tightly inserted into the through hole and the power connection hole, and a plurality of power connection terminals formed to pass upward and downward through the connector body.

17. The LED lighting device according to claim 15, wherein the power connector comprises a connector body having a shape suitable for being tightly inserted into the through hole and the power connection hole, and a plurality of power connection terminals disposed upward and downward in a side surface of the connector body such that portions of each of the power connection terminals are disposed in upper and lower surface of the connector body.
